(19) United States
(12) Patent Application Publication
(10) Pub. No.: US 2021/0115956 A1
(43) Pub. Date: Apr. 22, 2021

(54) DEVICE FOR RETENTION BY SNAP?FITTING OF A ROD

(71) Applicant: APLIX, LE CELLIER (FR)

(72) Inventors: Amaury BATAILLE, LE CELLIER (FR); Sylvain André Paul DROCHON, LE CELLIER (FR)

(73) Assignee: APLIX, Le Cellier (FR)

(21) Appl. No.: 15/733,288

(22) PCT Filed: Dec. 11, 2018
(86) PCT No.: PCT/FR2018/053209

§ 371 Date: Jun. 21, 2020

(30) Foreign Application Priority Data
Dec. 22, 2017 (FR) 1763149

(51) Int. Cl. F16B 5/06; F16B 2/24; B60N 2/58; F16L 3/04

(52) U.S. Cl. CPC F16B 5/0685; F16L 3/04; B60N 2/5825; F16B 2/245

(57) ABSTRACT

The invention relates to a retaining device by snap-fitting a rod connected to an object in the retaining device, the retaining device comprising an attachment base of the retaining device to the object and two wall elements, upright with respect to the attachment base and delimiting between them, at least partially with the attachment base, a receiving cavity of the rod which extends in a longitudinal direction, at least one of the wall elements being a retaining wall element having a longitudinal aperture, having an edge opposite to the attachment base delimiting a retaining tab of the rod in the cavity and forming a retaining edge of the rod in the cavity, the retaining tab having an inflection toward the other wall element.

### TECHNICAL FIELD

The present disclosure relates to a retaining device configured to be attached to an object and to allow the attachment of a rod by snap-fitting the rod into the retaining device.

The retaining device is particularly suited for the attachment of a cover of the slipcover type on an object, particularly a molded object, such as a motor vehicle seat cushion. The retaining device is also suited for guiding tubes or cables and/or for the attachment of cables.

### TECHNICAL BACKGROUND

A motor vehicle seat consists of a molded cushion, generally made of foam, covered by a cover, of fabric or of leather for example. Currently, to attach a cover fabric on the outer surface of a seat cushion of a motor vehicle, what is available, in one or more receiving grooves formed on the periphery of the cushion, are retaining elements adapted for cooperating with the cover by snap-fitting, abutment or even, more recently, self-gripping systems with hooks on hooks or hooks on loops. These retaining elements are usually encapsulated by the vehicle seat cushion, at its periphery, at the time when it is molded.

Patent application US2003/162008 describes a retaining element of this type in the general shape of a U, comprising two lateral walls delimiting an interior space intended to receive a rod secured to a fabric covering of the vehicle seat. Each lateral wall bears at its distal end a lug intended to cooperate by abutment or snap-fitting with a rod, to retain the cover around the vehicle seat cushion.

The attachment of the rod by abutment or snap-fitting, obtained with a system of this type, is not sufficiently reliable. Moreover, it is very difficult, even impossible, to undo this attachment without deteriorating the cover.

The patent application published under number WO 2011/089334 describe a retaining element of another type, comprising two lateral walls and a bottom delimiting a U-shaped groove, hooks suited to cooperate with loops or hooks originating in the cover protruding from the bottom of the retaining element.

However, all these systems exhibit difficulties in repositioning the slipcover. There exists, therefore, a need for a retaining device allowing the correction of the disadvantages of the prior art mentioned above and, in particular, which allow a reliable attachment resisting tension and which may be undone if needed without deterioration of the cover.

Also known are cable attachments, such as clamping collars. However, such collars have the disadvantage that, when it is desired to change the cable, it is necessary to cut the collar and replace it with a new clamping collar.

Other devices have been proposed, comprising teeth for holding the cable in a receiving cavity. However, it is not possible to withdraw the cable from the receiving cavity without damaging the cable. Which is not desirable.

There also exists a need for the attachment or guiding of cables and/or tubes, for example in the automotive field or in the building construction field, the retaining device allowing an attachment resistant to tension, and from which the cables and/or tubes may be withdrawn without damaging the cables and/or the tubes and/or without having to break the retaining device.

### Presentation

The present disclosure aims to correct these disadvantages, at least in part.

To this end, the present disclosure relates to a retaining device by snap-fitting a rod connected to an object in the retaining device, the retaining device comprising an attachment base of the retaining device to the object and two wall elements, upright with respect to the attachment base and delimiting between them, at least partially with the attachment base, a receiving cavity of the rod which extends in a longitudinal direction, at least one of the wall elements being a retaining wall element having a longitudinal aperture, having an edge opposite to the attachment base delimiting a retaining tab of the rod in the cavity and forming a retaining edge of the rod in the cavity, the retaining tab having an inflection toward the other wall element.

Thanks to the longitudinal aperture, i.e. extending in the longitudinal direction, the edge of which, opposite to the attachment base, delimits a retaining tab the rod in the cavity, the retaining tab has greater flexibility than the flexibility of the portion of the retaining wall element located between the aperture and the attachment base.

The longitudinal aperture delimits a retaining tab of the rod in the cavity and forms a retaining edge of the rod in the cavity. Thus it is understood that, along the longitudinal direction, a length of the longitudinal aperture is less than a length of the wall element. Thus, the retaining tab is a portion of the wall element and is attached to it.

What is meant by inflection of the retaining tab toward the other wall element is the fact that the retaining tab has a curved portion, the curved portion being closer to the other wall than a non-curved portion of the retaining tab. The inflection and the presence of the aperture allow a deformation of the retaining tab during the insertion of the rod into the cavity and also allow retaining the rod in the receiving cavity by means of the retaining edge of the rod in the cavity. It is also understood that a curved portion may be a generally rectilinear portion and having a nonzero angle relative to the non-curved portion of the retaining tab.

What is meant by a rod is any cylindrical element extending in the longitudinal direction. For example, the rod may be an element having the form of a right cylinder, solid or hollow, of which the base may be, for example, a circle, an ellipse, a triangle or any regular or irregular shape which may be used for a cylindrical element.

Moreover, the rod, though having the general shape of a cylinder, may be flexible.

What is meant by snap-fitting is the fact that the rod is passed by force between the retaining tab and the other wall element so that the retaining tab is deformed during the passage of the rod and resumes a shape equal or near to the shape prior to passage of the rod. The retaining tab resuming the shape equal or near to the shape prior to passage of the rod therefore allows retaining the rod in the receiving cavity of the rod.

Thanks to the shape of the receiving cavity and the retaining tabs of the rod in the receiving cavity, it is possible to reposition the rod after insertion in the receiving cavity, particularly in the longitudinal direction by sliding the rod in the receiving cavity without the rod being able to leave the receiving cavity.

It is understood that these features are present when the retaining device is not deformed (or in a “resting” state), i.e. when no rod is inserted in the cavity for receiving the rod or when there is no rod in the process of insertion into the cavity for receiving the rod.

The retaining device has a particular application for a seat, in particular for a motor vehicle seat, more particularly for a motor vehicle seat cushion.

In some embodiments, each of the two wall elements is a retaining wall element.

Thus, each of the two wall elements includes a longitudinal aperture having an edge opposite to the attachment base delimiting a retaining tab of the rod in the cavity and forming a retaining edge of the rod in the cavity, the retaining tab having an inflection toward the other wall element.

In some embodiments, the retaining tab has a maximum width in a plane perpendicular to the attachment base and a maximum thickness in a plane parallel to the attachment base, the maximum width being greater than the maximum thickness.

The retaining tab having a width greater than its thickness and the thickness being substantially parallel to the principal deformation direction of the tab. The tab may deform in a plane parallel to the attachment base while having a certain stiffness, and therefore smaller deformation, in a plane perpendicular to the attachment base.

In some embodiments, the ratio of the maximum width to the maximum thickness is greater than or equal to 1.1, and less than or equal to 4.0, preferably less than or equal to 3.5, more preferably less than or equal to 3.0.

In some embodiments, the longitudinal aperture extends between the retaining tab and the attachment base.

There is therefore no retaining wall element between the retaining tab and the attachment base, with the exception of at least one attachment of the retaining tab to the attachment base.

In some embodiments, the retaining tab comprises a free longitudinal end.

The retaining tab may therefore not be attached by each of its longitudinal ends to the retaining wall element.

In some embodiments, an amplitude of the inflection varies along the retaining tab.

The amplitude of the inflection of the retaining tab may therefore vary along the retaining tab when the retaining device is not deformed. The inflection of the retaining tab is therefore progressive. The amplitude is measured in a plane parallel to the attachment base and perpendicular to the longitudinal direction.

In some embodiments, a maximum amplitude of the inflection of the retaining tab in a plane parallel to the attachment base is greater than or equal to 10% of a maximum distance between the two wall elements, preferably greater than or equal to 15% and less than or equal to 80%, preferably less than or equal to 65%.

The distance is measured in the plane parallel to the base in a direction perpendicular to the longitudinal direction. It is understood that this distance is measured between the retaining tab and the wall element of which the retaining tab is a part. In particular, the distance is measured between the inner faces of the retaining tab element. Within the meaning of the disclosure, what is designated by “inner face” is a face of the retaining tab of a wall element and/or a face of a wall element which is a face turned toward the other wall element.

In some embodiments, the retaining tab includes an insertion ramp of the rod on an edge opposite to the retaining edge.

The insertion ramp of the rod allows the progressive deformation of the retaining tab during insertion of the rod. The insertion of a rod into the receiving cavity of the retaining device is thus made easier and more progressive. The force to be exerted to insert the rod into the retaining device is itself progressive. The progressive force to be exerted to insert the rod into the retaining device allow reducing the risks of musculoskeletal disorders (MSD) of operators in the assembly lines of automobile seats, for example.

In some embodiments, the insertion ramp has a maximum height in a plane perpendicular to the attachment base which is less than or equal to 90% of the maximum width of the retaining tab, preferably less than or equal to 80%.

The insertion ramp being present on a portion of the retaining tab, the retaining tab maintains sufficient stiffness, in particular stiffness allowing retaining the rod in the receiving cavity while still ensuring facilitated insertion.

In some embodiments, the insertion ramp is in a parallel to the longitudinal direction.

For example, the retaining tab may have a chamfer.

In some embodiments, the insertion ramp is in a plane intersecting the longitudinal direction.

For example, the retaining tab may have a decreasing width.

In some embodiments, a point of the retaining wall element farthest from the attachment base extends at most in a plane parallel to the attachment base comprising a point of the retaining tab farthest from the attachment base.

It is therefore understood that the retaining tab forms part of the retaining wall element which is opposite to the longitudinal aperture. Considering the attachment base as being the lower portion of the retaining device, the retaining tab is therefore in the upper portion of the retaining wall element.

In some embodiments, a passage distance between the two wall elements has a minimum value which is greater than or equal to 20% of a maximum distance between the two wall elements, preferably greater than or equal to 30% and less than or equal to 80%, preferably less than or equal to 70%, more preferably less than or equal to 60%, the distances being defined in as plane perpendicular to the longitudinal direction.

In some embodiments, a passage distance between the two wall elements defined in a plane perpendicular to the longitudinal direction has a minimum value comprised between 25% and 55% of a diameter of the rod that the retaining device is configured to retain.

What is meant by rod diameter is a dimension of the rod measured in a plane parallel to the attachment base and in a direction perpendicular to the longitudinal direction when the rod is retained in the cavity for receiving the rod of the retaining element, i.e. the diameter of the rod is measured in a plane perpendicular to the longitudinal direction X, parallel to the attachment base. It is understood that for a rod having the shape of a right cylinder with a circular base, the diameter of the rod is the diameter of the circle and may be measured in any direction in a plane perpendicular to the longitudinal direction. Depending on the application, the diameter of the rod may be greater than or equal to 1 mm (millimeter), preferably greater than or equal to 2 mm and less than or equal to 50 mm, preferably less than or equal to 30 mm, more preferably less than or equal to 20 mm.

In some embodiments a maximum height of the receiving cavity is less than or equal to 95% of a diameter of the rod that the device is configured to retain.

The maximum height of the receiving cavity is measured in a plane perpendicular to the longitudinal direction and in a direction perpendicular to the longitudinal direction and is the maximum distance between a point farthest from the receiving cavity and the retaining tab, in particular the retaining edge of the retaining tab. The farthest point defines the bottom of the receiving cavity.

In some embodiments, a ratio of an insertion force of the rod that the retaining device is configured to retain in the receiving cavity to an extraction force of the rod that the retaining device is configured to retain in the receiving cavity is less than or equal to 1 and greater than or equal to 0.05, preferably greater than or equal to 0.1, more preferably greater than or equal to 0.2.

Thus, the force required for the insertion of the rod into the receiving cavity is less than or equal to the force required to extract the rod from the receiving cavity.

In some embodiments, the retaining device is configured to attach a cover of the object by snap-fitting the rod.

In some embodiments, the attachment base includes through-holes.

The through-holes allow in particular attaching the retaining device to the object and also to reduce the cost and the mass of the retaining device. Surprisingly, despite the through-holes in the center of the attachment base, when for example the object is of foam and is formed around the retaining device, the foam penetrates very little into the receiving cavity and does not interfere with the operation of the retaining device, in particular that of the retaining tab. Surprisingly, it is not necessary to ensure complete sealing to protect the retaining device, in particular the receiving cavity, during the foaming operation. In fact, partial sealing is sufficient for the retaining device in order to ensure the operation of the retaining tab.

In some embodiments, the retaining device comprises a length comprised between 20 and 60 mm and/or a width comprised between 15 and 45 mm and/or a height comprised between 5 and 25 mm.

These dimensions allow a reduced bulk of the retaining device.

The present disclosure also relates to an assembly of a retaining device as previously defined, and of a rod retained in the retaining device.

In some embodiments, the rod includes hooks configured to cooperate with a counterpart with hooks or loops.

In some embodiments, the rod is assembled to an element of woven or non-woven material.

In the present disclosure, the term non-woven encompasses all the non-woven materials falling into the definition commonly accepted by a person skilled in the art, typically a material comprising fibers and/or filaments which are consolidated.

In some embodiments, the woven or non-woven material is applied directly to a coating intended to cover the object.

For example, the coating may be a cover cap for a motor vehicle seat cushion, the object being the cushion.

### BRIEF DESCRIPTION OF THE DRAWINGS

Other features and advantages of the object of the present disclosure will be revealed by the following description of embodiments, given by way of non-limiting examples, with reference to the appended drawings, in which:

FIG. 1 is a perspective view of a retaining device according to a first embodiment;

FIG. 2 is an elevation view of FIG. 1;

FIGS. 3 and 4 are side views of FIG. 1;

FIG. 5 is a perspective view of a retaining device according to a second embodiment;

FIG. 6 is an elevation view of FIG. 5;

FIGS. 7 and 8 are side views of FIG. 5;

FIG. 9 is a perspective view of a retaining device according to a third embodiment;

FIG. 10 is an elevation view of FIG. 9;

FIGS. 11 and 12 are side views of FIG. 9;

FIGS. 13 and 14 are perspective views of the rod.

In all the figures, the common elements are designated by identical numerical references.

### DETAILED DESCRIPTION

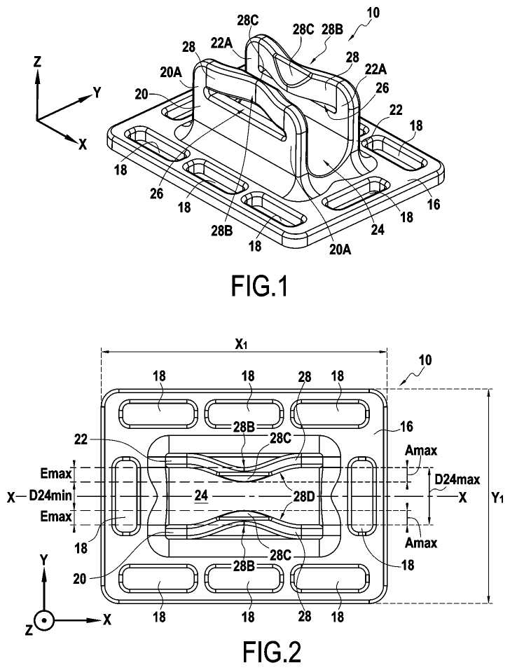

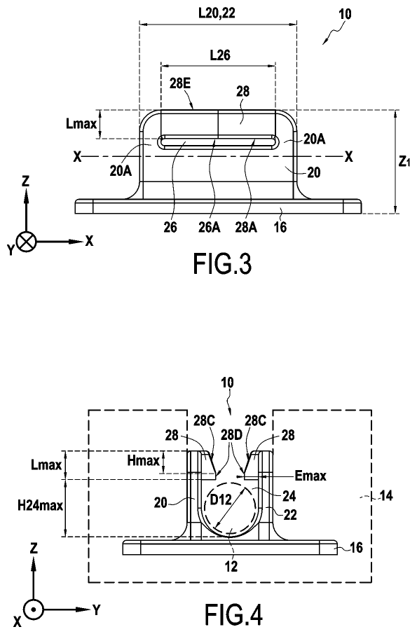

FIGS. 1 to 4 show a device 10 for retaining a rod 12 connected to an object 14 in the retaining device 10 in an orthogonal reference system XYZ. The rod 12 is for example a right cylinder with a circular base of diameter D12 extending in a longitudinal direction X.

The retaining device 10 comprises an attachment base 16 with a flat and substantially rectangular shape in a plane XY, including a plurality of through-holes 18 in the direction Z. The material forming the object 14, for example a foam for an automobile seat, may be present on each face of the attachment base 16 and pass through the through-holes 18. The retaining device 10 is thus attached on and in the object 14 and allows connecting the rod 12 to the object 14 by snap-fitting the rod 12 into the retaining device 10.

The retaining device 10 also comprises two wall elements 20, 22, upright relative to the attachment base 16 and delimiting between them, at least partially with the attachment base 16, a receiving cavity 24 of the rod 12. The receiving cavity 24 extends in a longitudinal direction X. The two wall elements 20, 22 are separated from one another by a maximum distance D24max measured in a plane parallel to the attachment base 16, i.e. a plane parallel to the plane XY, and in a direction perpendicular to the longitudinal direction X, i.e. in a transverse direction Y, and the two wall elements 20, 22 have, in the longitudinal direction X, a length L20, L22 of the wall element 20, 22. It is understood that this maximum distance D24max also represents the maximum width of the receiving cavity 24 measured in the direction perpendicular to the longitudinal direction X in a plane parallel to the attachment base 16 in which the receiving cavity 24 has a maximum width.

In the embodiment of FIGS. 1 to 4, each wall element 20, 22 has a longitudinal aperture 26 having an edge 26A opposite to the attachment base 16 delimiting a retaining tab 28 of the rod 12 in the receiving cavity 24 and forms a retaining edge 28A of the retaining tab 28 of the rod 12 in the receiving cavity 24. Each retaining tab 28 has an inflection 28B toward the other wall element. In the longitudinal direction X, the longitudinal aperture 26 has a length L26 which is less than the length L20, L22 of the wall elements 20, 22. The retaining tab 28 is therefore connected, at least longitudinal end, to the rest of the wall element 20, 22, and therefore to the attachment base 16, by attachment portions 20A, 22A of the wall element 20, 22.

The longitudinal aperture 26 therefore delimits the retaining edge 28A of the retaining tab 28. It is therefore understood that the retaining tab 28 forms a part of the wall element 20, 22 which is farthest from the attachment base 16, i.e. a point of the wall element 20, 22 farthest from the attachment base 16 extends at most in a plane parallel to the attachment base 16 comprising a point of the retaining tab 28 farthest from the attachment base 16.

In the embodiment of FIGS. 1 to 4, each retaining tab 28 is curved toward the other wall element. Thus, the retaining tab 28 of the wall element 20 is curved toward the wall element 22 and the retaining tab 28 of the wall element 22 is curved toward the wall element 20.

The retaining tab 28 has a maximum width Lmax measured in a plane perpendicular to the attachment base 16, for example a plane parallel to the plane XZ, in a direction perpendicular to the longitudinal direction X, i.e. in a direction Z perpendicular to the plane XY, and a maximum thickness Emax measured in a plane parallel to the attachment base 16 and in the transverse direction Y.

In this embodiment, the ratio of the maximum width Lmax to the maximum thickness Emax is greater than or equal to 1.1 and less than or equal to 4.0, preferably less than or equal to 3.5, more preferably less than or equal to 3.0. For example, the ratio of the maximum width Lmax to the maximum thickness Emax is equal to 2, i.e. the maximum width Lmax is equal to twice the maximum thickness Emax.

In the embodiment of FIGS. 1 to 4, an amplitude of the inflection of the retaining tab 28 varies along the retaining tab 28. Thus, the retaining tab 28 has a maximum amplitude of the inflection Amax where the distance between the retaining tab 28 of the wall element 20 and the other wall element 22 is a minimum. At this maximum inflection amplitude point of the inflection Amax, the distance separating the retaining tab 28 and the wall element 20 bearing the retaining tab 28 is a maximum. It is measured in a plane parallel to the attachment base 16 and perpendicular to the longitudinal direction X.

The maximum retaining tab 28 inflection amplitude Amax of the retaining element 20 is greater than or equal to 10% of the maximum distance D24max between the two wall elements 20, 22, preferably greater than or equal to 15% and less than or equal to 80%, preferably less than or equal to 65%.

In the embodiment of FIGS. 1 to 4, the maximum inflection amplitude Amax between the retaining tab 28 of the retaining element 20 at is maximum amplitude point and the retaining element 20 bearing the retaining tab 28 is for example equal to 25% of the maximum distance D24max between the two wall elements 20, 22.

Each retaining tab 28 includes an insertion ramp 28C. The insertion ramp 28C is a surface comprised in a plane parallel to the longitudinal direction X. The insertion ramp 28C is for example a chamfer located on an inner face 28D of an edge 28E opposite to the attachment base 16 of the retaining tab 28. It is understood that the expression “inner” relates to the receiving cavity 24. An inner face 28D of the retaining tab 28 of a wall element being a face turned toward the other wall element. Likewise, the inner face of a wall element is a face turned toward the other wall element.

As shown in particular in FIG. 4, the insertion ramp 28C has a maximum height Hmax in a plane perpendicular to the attachment base 16 which is less than or equal to 90% of the maximum width Lmax of the retaining tab 28, preferably less than or equal to 80%.

As shown in FIG. 2 in top view, the two retaining tabs 28 of the retaining device 10 define a passage distance between the two wall elements 20, 22 having a minimum value D24min which is greater than or equal to 20% of the maximum distance D24max between the two wall elements 20, 22, preferably greater than or equal to 30% and less than or equal to 80%, preferably less than or equal to 70%, more preferably less than or equal to 60%, the distances being defined in a plane perpendicular to the longitudinal direction X. The passage distance between the two wall elements 20, 22 is defined between the retaining tabs 28. For example, the minimum value D24min of the passage distance between the two retaining tabs 28 of the retaining device 10 is equal to 50% of the maximum distance D24max between the two wall elements 20, 22.

The passage distance between the two wall elements 20, 22 defined in a plane perpendicular to the longitudinal direction X has a minimum value D24min comprised between 25% and 55% of the diameter D12 of the rod 12 that the retaining device 10 is configured to retain. For example, the minimum value D24min of the passage distance between the two retaining tabs 28 of the retaining device 10 is equal to 50% of the diameter D12 of the rod 12.

It is understood that the retaining device 10 is configured to retain the rod 12 with diameter D12.

The retaining device is such that a ratio of an insertion force of the rod 12 of diameter D12 in the receiving cavity to an extraction force of the rod 12 of diameter D12 in the receiving cavity 24 is less than or equal to 1 and greater than or equal to 0.05, preferably greater than or equal to 0.1, more preferably greater than or equal to 0.2.

Thus, the force required for the insertion of the rod into the receiving cavity is less than or equal to the force required to extract the rod from the receiving cavity.

Solely by way of a non-limiting example, the maximum inflection amplitude Amax of the retaining tab 28 may be equal to 2 mm, the maximum distance D24max between the two wall elements 20, 22 may be equal to 8 mm, the minimum value D24min of the passage distance between the two retaining tabs 28 of the retaining device 10 may be equal to 4 mm and the diameter D12 of the rod 12 that the retaining device 10 is configured to retain may be equal to 8 mm.

Thus, the maximum inflection amplitude Amax of the retaining tab 28 is equal to 25% of the maximum distance D24max between the two wall elements 20, 22, the minimum value D24min of the passage distance between the two retaining tabs 28 of the retaining device 10 is equal to 50% of the maximum distance D24max between the two wall elements 20, 22 and the minimum value D24min of the passage distance between the two retaining tabs 28 of the retaining device 10 is equal to 50% of the diameter D12 of the rod 12.

For example, thanks to the retaining device 10, it is possible to attach a cover, such as a cap, to the object 14, for example an automobile seat foam cushion, by snap-fitting the rod 12 into the retaining device 10.

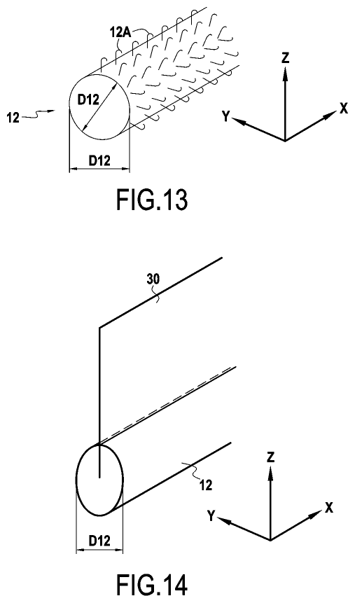

The rod 12 may include hooks 12A configured to cooperate with a counterpart with hooks or loops attached to the cap (see FIG. 13).

The rod 12 may be assembled to an element 30 of woven or non-woven material, for example by encapsulating the rod 12 on the element 30, the element 30 being assembled to the cap (see FIG. 14).

In the embodiment of FIG. 14, the rod 12 is a right cylinder with an elliptical base. The rod 2 is configured to be inserted into the receiving cavity 24 of the retaining device 10 so that the element 30 is substantially perpendicular to the attachment base 16 of the retaining device 10. Thus, the diameter D12 of the rod 12 is the minor diameter of the ellipse forming the base of the rod 12.

In the embodiment of FIGS. 1 to 4, each of the wall elements 20, 22 is a retaining wall element. However, the retaining device 10 may include only a single retaining wall element, the other wall element not being a retaining wall element.

In the embodiment of FIGS. 1 to 4, each of the retaining tabs is arranged in the center of the length of the wall element. However, these tabs could have a different shape or arrangement, for example offset from one another.

Hereafter, the elements common to the different embodiments are identified by the name numerical references.

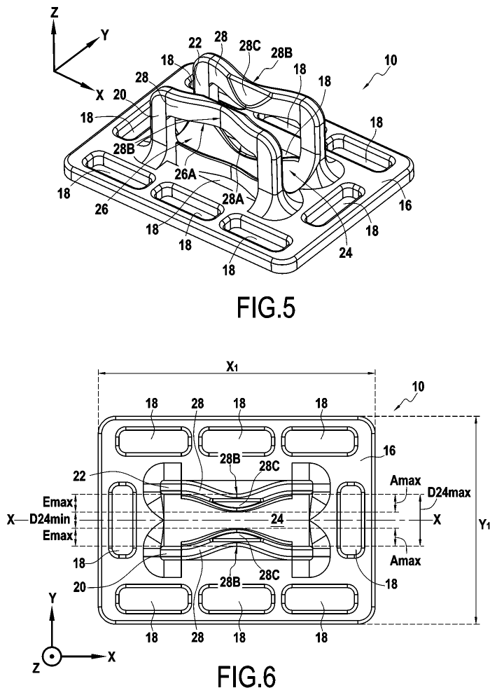

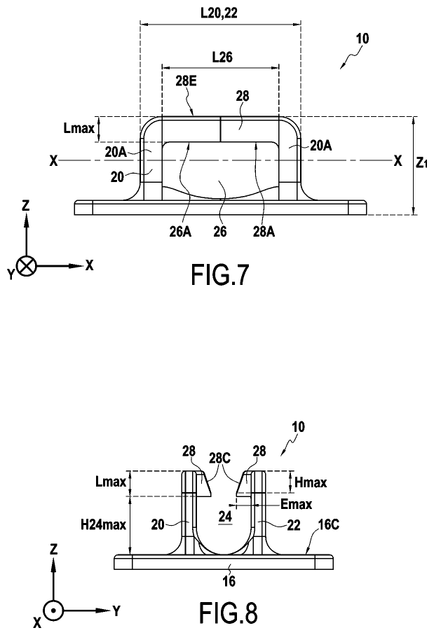

The embodiment of FIGS. 5 to 8 differs from the embodiment of FIGS. 1 to 4 in that the aperture 26 extends between the retaining tab 28 and the attachment base 16. The retaining tab 28 is therefore attached to the attachment base 16 by the wall elements 20, 22, forming, for each wall element 20, 22, two attachment tabs 20A, 22A from the retaining pad 28 to the attachment base 16, each attachment tab 20A, 22A being located at a longitudinal end of the retaining tab 28. In addition, the bottom of the receiving cavity 24 is in the same plane as the attachment base 16, in particular a surface 16C of the attachment base 16, this surface 16C being closest to the receiving cavity 24.

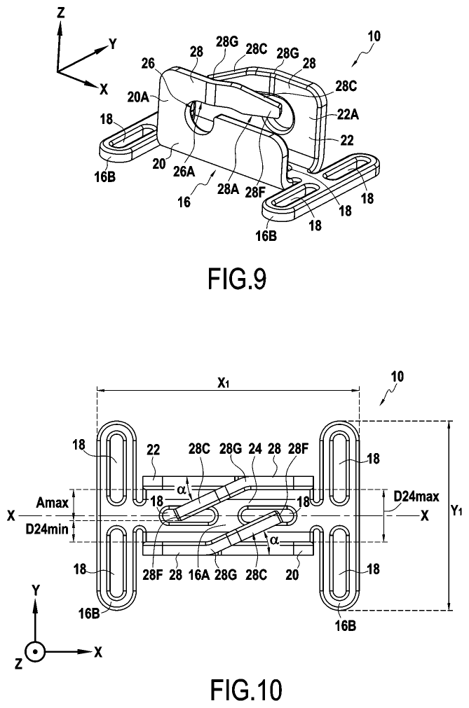

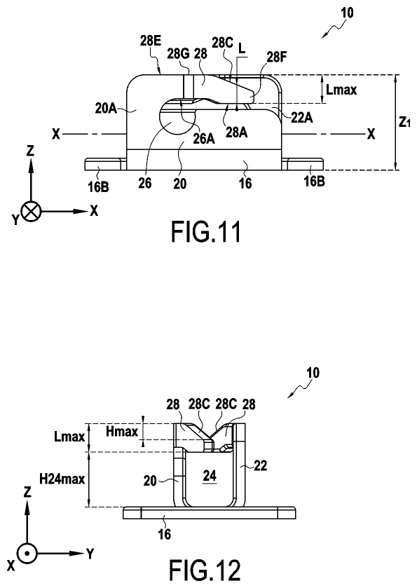

FIGS. 9 to 12 differ from the preceding embodiments in that in particular the retaining tab 28 has a free end 28F, i.e. the retaining tab 28 is connected to the attachment base 16 by a single attachment portion 20A, 22A. The retaining tab 28 is therefore connected to the attachment base 16 by only one of its longitudinal ends.

It will be noted that, in this embodiment, a portion of the attachment base 16 delimiting, with the two wall elements 20, 22, the receiving cavity 24 comprises through-holes 18. The attachment base 16 has a portion 16A extending in the longitudinal direction X and delimiting, at least partially with the wall elements 20, 22, the receiving cavity 24 and, at each longitudinal end of the receiving cavity 24, the attachment base 16 comprises an attachment tab 16B of the retaining device 10.

In the embodiment of FIGS. 9 to 12, the inflection of the retaining tab 28 is formed by an elbow 28G. The retaining tab 28 forms a nonzero angle α with the wall element 20, 22. Between the elbow 28G and the free end 28F of the retaining tab 28, the retaining tab 28 is rectilinear in top view. The free end 28F of the retaining tab is directed toward the other wall element and is closer to the other wall element than the elbow 28G.

In the embodiment of FIGS. 9 to 12, the insertion ramp 28C is in a plane intersecting the longitudinal direction X. The retaining tab 28 has a width L which decreases toward the free end 28F of the retaining tab 28.

Just as in the embodiments previously described, the insertion ramp 28 has a maximum height Hmax in a plane perpendicular to the attachment base 16 which is less than or equal to 90% of the maximum width Lmax of the retaining tab 28, preferably less than or equal to 80%.

In the embodiment of FIGS. 9 to 12, the minimum value D24min of the passage distance between the two wall elements 20, 22 is defined between the retaining tab 28 of the wall element 20 and the wall element 22, or conversely between the retaining tab 28 of the wall element 22 and the wall element 20, and more particularly between the free end 28F of the retaining tab 28.

Solely by way of a non-limiting example, the maximum inflection amplitude Amax of the retaining tab 28 may be equal to 5 mm, the maximum distance D24max between the two wall elements 20, 22 may be equal to 8 mm, the minimum value D24min of the passage distance between one of the two retaining tabs 28 of one of the wall elements 20, 22 and the other wall element 22, 20 may be equal to 3 mm and the diameter D12 of the rod 12 that the retaining device 10 is configured to retain may be equal to 7 mm.

Thus, the maximum inflection amplitude Amax of the retaining tab 28 is equal to 62.5% of the maximum distance D24max between the two wall elements 20, 22, the minimum value D24min of the passage distance between one of the two retaining tabs 28 of one of the wall elements 20, 22 and the other wall element 22, 20 is equal to 37.5% of the maximum distance D24max between the two wall elements 20, 22 and the minimum value D24min of the passage distance between the two retaining tabs 28 of the retaining device 10 is equal to 42.9% of the diameter D12 of the rod 12.

In the embodiment of FIGS. 9 to 12, between the elbow 28G and the free end 28F of the retaining tab 28, the retaining tab 28 is rectilinear in top view.

The materials used to produce a device of this type may be of plastic, for example polyethylene (PE), polyoxymethylene (POM), polyamide (PA), rubber having a certain stiffness, a metallic material, for example steel or aluminum, a composite material, for example a plastic material reinforced for example with glass fibers and/or carbon fibers or a mixture of these material, for example different plastics and/or a plastic material with a composite material. The methods used for the manufacture of a device of this type may be, for example in a non-limiting manner, a plastic injection method or sheet metal cutting/stamping. The device may be formed in a single piece.

In the embodiments shown in the figures, the retaining device 10 comprises a length X1 of approximately 40 mm, a width Y1 of approximately 30 mm and a height Z1 of approximately 15 mm, the retaining device 10 thus having reduced bulk for a rod 12 with a dimension comprised between 3 and 15 mm. A person skilled in the art may easily vary the dimensions of the retaining device 10 depending on the dimensions of the rod 12.

Although the present disclosure has been described while referring to a specific embodiment, it is obvious that different modifications and changes may be carried out on these examples without departing from the general scope of the invention as defined by the claims. In addition, individual features of the different embodiments mentioned may be combined into additional embodiments. Consequently, the description and the drawings should be considered illustrative rather than restrictive.

The retaining device 10 may be used for the attachment or the guiding of cables and/or tubes, for example in the automotive field or in the building construction field, the retaining device 10 allowing a reliable attachment resisting tension, and from which cables and/or tubes may be extracted without damaging the cables and/or tubes and/or without having to break the retaining device. The retaining device 10 may include elements for attachment to the object 14 attached to the attachment base 16. The different embodiments could have through-holes 18 in the portion of the attachment base 16 delimiting the receiving cavity 24. Likewise, the portion of the attachment base 16 delimiting the receiving cavity 24 of the embodiment of FIGS. 9 to 12 could be solid and therefore not include through-holes 18. The shape of the attachment base 16 is not limited to the shapes presented in the different embodiments described. It is understood that the shape of the attachment base 16 may be modified in order to adapt it to the object 14 to which the attachment base 16 is assembled and/or attached. The retaining device 10 may be attached to the object 14 by encapsulating the object 14 on the attachment base 16, by mechanical clamping of the attachment base 16 to the object 14, for example with clamping collars passing through the through-holes 18, by passing screws or nails through the through-holes 18 and/or by modification of the attachment base. In the embodiments presented, the wall element 20, 22, in a plane perpendicular to the attachment base 16 and parallel to the longitudinal direction X, has the general shape of a rectangle elongated in the longitudinal direction. The general shape of the wall element 20, 22 may be a circular arc in the form of a hoop, the arc or the hoop therefore being formed by a portion of the retaining tab 28.

1. A retaining device by snap-fitting a rod connected to an object in the retaining device the retaining device comprising an attachment base of the retaining device to the object and two wall elements upright relative to the attachment base and delimiting between them, at least partially with the attachment base, a receiving cavity of the rod which extends in a longitudinal direction at least one of the wall elements being a retaining wall element having a longitudinal aperture, having an edge opposite to the attachment base delimiting a retaining tab of the rod in the cavity and forming a retaining edge of the rod in the cavity, the retaining tab having an inflection toward the other wall element.

2. The retaining device according to claim 1, wherein the retaining tab has a maximum width in a plane perpendicular to the attachment base and a maximum thickness in a plane parallel to the attachment base, the maximum width being greater than the maximum thickness.

3. The retaining device according to claim 1, wherein the longitudinal aperture extends between the retaining tab and the attachment base.

4. The retaining device according to claim 1, wherein the retaining tab comprises a free longitudinal end.

5. The retaining device according to claim 1, wherein an amplitude of the inflection varies along the retaining tab.

6. The retaining device according to claim 5, wherein a maximum amplitude (Amax) of the inflection of the retaining tab in a plane parallel to the attachment base is greater than or equal to 10% of a maximum distance between the two wall elements and less than or equal to 80%.

7. The retaining device according to claim 1, wherein the retaining tab includes an insertion ramp of the rod on an edge opposite to the retaining edge.

8. The retaining device according to claim 7, wherein the insertion ramp is in a parallel to the longitudinal direction.

9. The retaining device according to claim 7, wherein the insertion ramp is in a plane intersecting the longitudinal direction.

10. The retaining device according to claim 1, wherein one point of the retaining wall element farthest from the attachment base extends at most in a plane parallel to the attachment base comprising a point of the retaining tab farthest from the attachment base.

11. The retaining device according to claim 1, wherein a passage distance between the two wall elements has a minimum value which is greater than or equal to 20% of a maximum distance between the two wall elements and less than or equal to 80%, the distances being defined in a plane perpendicular to the longitudinal direction.

12. The retaining device according to claim 1, wherein a passage distance between the two wall elements defined in a plane perpendicular to the longitudinal direction has a minimum value comprised between 25% and 55% of a diameter of the rod that the retaining device is configured to retain.

13. The retaining device according to claim 1, wherein a ratio of an insertion force of the rod that the retaining device is configured to retain in the receiving cavity to an extraction force of the rod that the retaining device is configured to retain in the receiving cavity is less than or equal to 1 and greater than or equal to 0.05.
